(19) United States
(12) Patent Application Publication
(10) Pub. No.: US 2017/0001846 A1
(43) Pub. Date: Jan. 5, 2017

(54) TELEHANDLER

(71) Applicant: Dinolift Oy, Loimaa (FI)

(72) Inventor: Petri PAAVOLAINEN, Espoo (FI)

(21) Appl. No.: 15/194,910

(22) Filed: Jun. 28, 2016

(30) Foreign Application Priority Data
Jun. 30, 2015 (FI) 20155518

(51) Int. Cl. B66F 11/04; B66C 13/40; B66F 9/075

(52) U.S. Cl. CPC B66F 11/046; B66F 9/07581; B66C 13/40

(57) ABSTRACT

According to one embodiment, the application relates to a telehandler (100), which includes a chassis section (110) and a boom assembly (120) supported on the chassis section and capable of being fitted with a liftable attachment (130). The telehandler further includes a control unit (112), including chassis control elements (114) for controlling the chassis section and/or boom assembly control elements (116) for controlling the boom assembly. The control unit is adapted to be operated from outside the unmanned telehandler.

### TECHNICAL FIELD

The application relates generally to a telehandler.

### BACKGROUND

A telehandler is a heavy machine intended for moving objects, comprising a long telescopic boom on the end of which can be fitted e.g. forklift prongs, a bucket or a man basket.

The operator of a wheeled telehandler is sitting in a cab constructed on its chassis, from where the operator controls motion of the telehandler and operation of the forklift prongs or the like at the end of a boom.

The operator's visibility from cab to work stage is poor when restricted by the telescopic boom, thereby impeding and hindering operation of the telehandler.

### SUMMARY

It is one objective of the invention to overcome problems of the prior art and to provide a side- and/or remote-controlled unmanned controllable telehandler, which enables a reduction in the number of heavy machines needed at worksites as it is possible to use the telehandler both in moving materials and objects and also as a personnel lift.

The one objective of the invention is attained with a telehandler of claim 1 and a man basket of claim 10.

The telehandler according to one embodiment comprises a chassis section and a boom assembly supported on the chassis section and capable of being fitted with a liftable attachment. The telehandler further comprises a control unit, including chassis control means for controlling the chassis section and/or boom assembly control means for controlling the boom assembly. The control unit is adapted to be operated from outside the unmanned telehandler.

The chassis section stands for e.g. a wheeled and/or tracked telehandler chassis, which enables a transfer of the telehandler from one place to another and on which can be supported e.g. a lifting section of the telehandler which may comprise e.g. a boom assembly and a slewing mechanism intended for rotating the same.

According to one embodiment there is a man basket for attachment to a telehandler that comprises a chassis section and a boom assembly supported on the chassis section and enabling an attachment of the basket. The telehandler further comprises a control unit with chassis control means for operating the chassis portion and/or boom assembly control means for operating the boom assembly. The control unit is adapted to be operated from outside the unmanned telehandler. The basket comprises fastening elements for the attachment of a lifting fork, locking elements for locking the lifting fork securely to the fastening elements, and observation elements for monitoring electrically the locking status of the locking elements.

Other embodiments are presented in the dependent claims.

### BRIEF DESCRIPTION OF THE FIGURES

It is in the detailed description of the figures that embodiments of the invention will be recounted more precisely with reference to the accompanying figures, in which

FIG. 1a shows a lifting fork-equipped telehandler and a man basket apart from each other, and

FIGS. 1b-1c show from different perspectives a telehandler equipped with a man basket attached to the lifting fork.

### DETAILED DESCRIPTION OF THE FIGURES

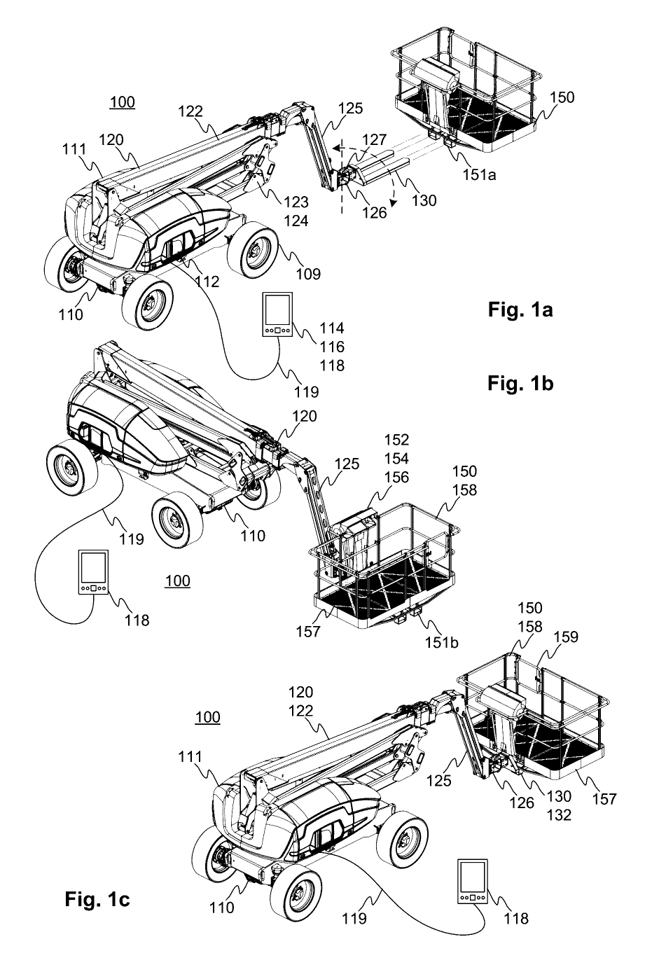

FIG. 1a shows a telehandler 100, which comprises a chassis section 110 equipped with wheels 109.

The telehandler 100 comprises a lifting section, which is supported on the chassis section 110 and which comprises a boom assembly 120 used for operating in vertical and lateral directions a liftable attachment 130 mounted to its end and present in a working section, and a slewing mechanism enabling to effect rotation of the boom assembly 120.

The slewing mechanism can have a turning radius of 360 degrees, whereby it can be used for maneuvering the boom assembly 120 in a desired direction without moving the chassis section 110.

Alongside the boom assembly 120, on top of the slewing mechanism, can be mounted a motor 111, e.g. a diesel, electric or hybrid motor, which functions as a power source for moving the telehandler 100 by means of the wheels 109.

In an upper part of the boom assembly 120 can be a telescopic boom 122 capable of being used for extending and retracting an end of the boom assembly 120 co-directionally with the boom 122, and a linkage 124, which consists of booms 123 articulated to each other at the ends thereof, and which is supported on the slewing mechanism and which is adapted to operate the boom 122.

In addition, the boom assembly 120 may include a jib 125, which is mounted by articulation to an end of the boom 122. It is by means of the jib 125 that maneuvering of the liftable attachment 130 is possible in such a way that the liftable attachment 130 pivots, e.g. 180 degrees, with respect to the vertical axis of a connection point 126 between the jib 125 and the liftable attachment 130.

A motor intended for operating the components 122, 123, 124, 125 of the boom assembly 120 can be mounted alongside the boom assembly 120, on top of the slewing mechanism.

A motor for the boom assembly 120 can be the motor 111 intended for operating the telehandler 100.

Movements of the components 122, 123, 124, 125 of the boom assembly 120 can be executed hydraulically or electrically.

The telehandler 100 comprises a control unit 112 for operating the same.

The control unit 112 may include chassis control means 114 for controlling the motor 111 and other functions of the chassis section 110, e.g. for controlling the driving wheels 109.

The control unit 112 may further include boom assembly control means 116 for controlling the boom assembly 120 and its motor.

The liftable attachment 130 can be for example a lifting fork (forklift prongs), a work platform, a hoisting winch, a lifting cable or a bucket.

In the lifting fork 130 as illustrated in the figures, the lifting prongs, the number of which can be two or more, can be fixed or adjustable in terms of a distance between each other.

The lifting fork 130 is attached to the jib 125 and electrically coupled with the control unit 112 by way of the boom assembly 120, e.g. a cable system installed therein, for maneuvering it with the boom assembly control means 116.

The control unit 112 is mounted alongside the boom assembly 120, e.g. on top of the slewing mechanism or on the chassis section 110, and it is adapted to be operated from outside the telehandler 100, for a so-called side-controlled unit, whereby the operator of the telehandler 100 is standing or moving alongside it while maneuvering the telehandler at a worksite or while controlling the boom assembly 120. Having the telehandler 100 controlled from alongside facilitates and expedites its operation as the boom assembly 200 does not impede the operator's visibility, whereby he/she has a good visibility from a control spot to the work stage and to a load to be handled, as opposed to telehandlers equipped with an operator's cab.

In addition, by virtue of side control, operating the telehandler 100 is safer than that of telehandlers provided with operator's cabs as the load to be handled with the boom assembly 120 is continuously visible alongside the operator because, by virtue of side control, the operator has more freedom in choosing the control spot so as to maintain a visual contact with the work stage and the load.

In addition, by virtue of side control, no extra assistant is needed to help the operator's observation when maneuvering the boom assembly 120 at a site.

The control unit 112 may comprise not only the control means 114, 116 but also a portable control device 118, which is in telecommunication 119 with the control unit 112, e.g. by means of a cable connection or a wireless connection, e.g. radio or infrared communication.

The control device 118 may have respective control means 114, 116 similar to those of the control unit 112, or it may only have one of the control means 114, 116, e.g. the control means 114.

The control unit 112 may comprise one or both of the control means 114, 116 in the control device 118 only, in which case the telehandler 100 cannot be controlled from anywhere else except from the control device 118.

The portable control device 118 enables the chassis section 110 and/or the boom assembly 120 to be remotely controlled from outside the telehandler 100 at some distance alongside the same, depending on the employed connection, the operator having a better-than-before visibility to where the lifting fork 130 is working.

The cable connection 119 can be e.g. 2-3 m in length, the distance of radio communication (range) e.g. 0-100 m, and the distance of infrared communication e.g. 0-10 m.

By virtue of wireless communication, the operator is able to choose a control spot from around the telehandler 100, e.g. from the front, from the side or from behind, more freely within the range of wireless communication than in the case of the cable connection 119, whereby the benefits of side control, e.g. easiness, speed, good visibility and safety, become even more pronounced than before.

FIGS. 1b-1c illustrate the telehandler 100 and a man basket 150 attached to its lifting fork 130.

The basket 150 has a floor 157, upon which people and goods to be raised can be present, and railings 158 for protecting people and things present in the basket 150 against falling from the basket 150.

The basket 150 may further include a loading gate 159, enabling the loading therein of people and goods.

The basket 150 can have its width and depth as well as its gate 159 dimensioned so as to enable placing on the floor 157 a pallet, e.g. an EUR-pallet of 1.2 m×0.8 m, and stacking the same on top of each other as necessary.

The basket 150 comprises fastening elements 151a, 151b, which are fitted under the floor 157 and into which the prongs of the lifting fork 130 are pushed as shown in the figures, such that one of the prongs works its way into the fastening element 151a and the other prong into the fastening element 151b. The basket 150 attaches in a removable manner to the lifting fork 130, whereby the lifting fork 130, which is fixedly attached to the jib 125, has its prongs functioning as a fastening and bearing member for the basket 150. The basket 150 is removable from the attachment by pulling the lifting fork 130 out of the fastening elements 151a, 151b.

The fastening elements 151a, 151b may comprise e.g. fastening loops made of metal, solid fastening sleeves made of two U profiles by welding, or partially open fastening sleeves made of a C profile.

The material for the basket 150 and the fastening elements 151a, 151b can be e.g. galvanized or paint coated steel.

The lifting fork 130 is locked securely into the fastening elements 151a, 151b with locking elements 132, e.g. with at least one quick release locking pin, locking screw or cotter pin, ensuring that the basket 150 remains in attachment with the lifting fork 130.

The fastening elements 151a, 151b and the illustrated locking pin 132 enable a quick coupling and release of the basket 150, whereby the intended function of the telehandler 100 can be rapidly converted from transferring goods to lifting personnel and vice versa. A quick conversion of the telehandler 100 into the personnel lift 100 makes it possible to employ a single telehandler 100 instead of two different heavy machines—a telehandler and a personnel lift—thus reducing the number of heavy machines, costs incurred thereby, and congestion at worksite.

In addition, the telehandler 100 diminishes the need for transporting heavy equipment because, as opposed to two heavy machines, it is sufficient to transport the telehandler 100 along to a worksite.

In addition, the telehandler 100 reduces costs and is environmentally friendly since, by virtue thereof, the fuel consumption is reduced in transport and at worksite with a reduced number of heavy machines at worksite and the transport equipment being required to carry just the telehandler 100.

The basket 150 can be provided with a basket control unit 152, possibly including chassis control means 154 which enable the chassis section 110 to be controlled from the basket 150 in a manner similar to the chassis control means 114.

The basket control unit 152 can be further provided with boom assembly control means 156 which enable a the boom assembly 120, the lifting fork 130, and the basket 150 attached thereto to be controlled from the basket 150 in a manner similar to the boom assembly control means 116.

The basket 150—the basket control unit 152—is electrically connectible to the control unit 112 by means of the boom assembly 120, e.g. a cable system installed therein, and by means of a quick release coupling included in the jib 125 and functioning as a connection unit 127

The locking elements 132 can have its locking status observed with monitoring elements, e.g. with at least one electrical or mechanical switch or with a hydraulic valve (switch), which disallow movements of the basket 150 if the quick coupling 127 of the basket control unit 152 is engaged, but the locking elements 132 are not in a locking position.

Disconnection of the basket 150 is carried out in such a way that the boom 122 is driven out and the basket 150 is lowered e.g. onto the ground, into a storage facility or onto a shelf. The basket control unit 152 has its quick coupling 127 released and the engaged locking elements 132 are unlocked. This is followed by driving the boom 122 in, whereby the lifting fork 130 has its prongs released from the fastening elements 151a, 151b present under the floor 157.

Attachment of the basket 150 is carried out in reverse order. The boom 122 is driven out in such a way that the lifting fork 130 has its prongs engaging with the fastening elements 151a, 151b of the basket 150 resting e.g. on the ground, in a storage facility or on a shelf. The basket 150 is locked by securing the locking elements 132 and the quick coupling 127. This is followed by lifting the basket 150 off the ground and by driving the boom 122 in.

The foregoing only discloses a few embodiments of the invention. The principle according to the invention can be naturally varied within the scope of protection defined by the claims, regarding for example implementation details as well as fields of use.

1. A telehandler (100), comprising
a chassis section (110),
a boom assembly (120) supported on the chassis section and capable of being fitted with a liftable attachment (130), and
a control unit (112), including chassis control means (114) for controlling the chassis section and/or boom assembly control means (116) for controlling the boom assembly, wherein
the control unit is adapted to be operated from outside the unmanned telehandler.

2. A telehandler according to claim 1, wherein the control unit comprises a portable control device (118), which is in telecommunication (119) with the control unit and enables the chassis section and/or the boom assembly to be controlled from a certain distance outside the chassis section.

3. A telehandler according to claim 1, wherein the boom assembly includes a telescopic boom (122) and a linkage (124), which is supported on a boom assembly slewing mechanism and which is adapted to operate the boom.

4. A telehandler according to claim 3, wherein the boom assembly further includes a jib (125), which is connected to the boom and which is adapted to operate a liftable attachment in such a way that the liftable attachment rotates with respect to the vertical axis of its connection point (126).

5. A telehandler according to claim 4, wherein the liftable attachment is connected to the jib and electrically coupled with the control unit by means of the boom assembly for controlling the liftable attachment with the boom assembly control means.

6. A telehandler according to claim 1, wherein the liftable attachment is a lifting fork (130).

7. A telehandler according to claim 6, which is further provided with a man basket (150) which is releasably attachable to the lifting fork and electrically connectible to the control unit by way of the boom assembly and by means of a connection unit (127) of the jib.

8. A telehandler according to claim 1, wherein the basket comprises fastening elements (151a, 151b) capable of having the lifting fork attached thereto, and locking elements (132) by means of which the lifting fork is capable being locked securely to the fastening elements and the locking status of which are electrically observed with monitoring elements.

9. A telehandler according to claim 1, wherein the basket is provided with a basket control unit (152), including chassis control means (154) for controlling the chassis section and boom assembly control means (156) for controlling the boom assembly and the lifting fork connected thereto, said basket control unit being electrically connected to the control unit.

10. A man basket (150) for attachment to a telehandler (100) according to claim 1, said basket comprising
fastening elements (151a, 151b) capable of having a lifting fork (130) attached thereto,
locking elements (132) for locking the lifting fork securely to the fastening elements, and
observation elements for electrically monitoring the locking status of the locking elements.

11. A telehandler according to claim 2, wherein the liftable attachment is a lifting fork (130).

12. A telehandler according to claim 2, wherein the basket comprises fastening elements (151a, 151b) capable of having the lifting fork attached thereto, and locking elements (132) by means of which the lifting fork is capable being locked securely to the fastening elements and the locking status of which are electrically observed with monitoring elements.

13. A telehandler according to claim 2, wherein the basket is provided with a basket control unit (152), including chassis control means (154) for controlling the chassis section and boom assembly control means (156) for controlling the boom assembly and the lifting fork connected thereto, said basket control unit being electrically connected to the control unit.

14. A telehandler according to claim 3, wherein the liftable attachment is a lifting fork (130).

15. A telehandler according to claim 3, wherein the basket comprises fastening elements (151a, 151b) capable of having the lifting fork attached thereto, and locking elements (132) by means of which the lifting fork is capable being locked securely to the fastening elements and the locking status of which are electrically observed with monitoring elements.

16. A telehandler according to claim 3, wherein the basket is provided with a basket control unit (152), including chassis control means (154) for controlling the chassis section and boom assembly control means (156) for controlling the boom assembly and the lifting fork connected thereto, said basket control unit being electrically connected to the control unit.
